(19) United States
(12) Patent Application Publication
(10) Pub. No.: US 2025/0111500 A1
(43) Pub. Date: Apr. 3, 2025

(54) BLOOD VESSELS AND LESION SEGMENTATIONS BY DEEP NEURAL NETWORKS TRAINED WITH SYNTHETIC DATA

(71) Applicant: TECHSOMED MEDICAL TECHNOLOGIES LTD, Rehovot (IL)

(72) Inventor: Tom EDLUND, Neve Shalom (IL)

(73) Assignee: TECHSOMED MEDICAL TECHNOLOGIES LTD, Rehovot (IL)

(21) Appl. No.: 18/477,599

(22) Filed: Sep. 29, 2023

(51) Int. Cl. G06T 7/00; G06T 7/174; G06T 17/00

(52) U.S. Cl. CPC G06T 7/0012; G06T 7/174; G06T 17/00; G06T 2207/20081; G06T 2207/20084; G06T 2207/30096; G06T 2207/30101

(57) ABSTRACT

Systems and methods for training deep neural networks (DNNs) for blood vessel and lesion segmentation using synthetically generated training data, are provided. Systems may comprise parametric simulation modules for generating 3D branching blood vessels and 3D lesion structures and an augmentation module configured to add noise, background and organ boundaries to the 3D models, to yield the synthetic training data for training the DNNs. The 3D vessel model may be generated as a hierarchical tree comprising segments that are generated as anti-aliased lines with specified length and start and end thicknesses, which are elongated by segment addition(s) and/or by branching to follow semi-linear or curved lines, while avoiding overlapping of segments. The 3D lesion model and/or combined vessel/lesion models may be generated using multiple input images such as contrast enhancement phases.

### BACKGROUND OF THE INVENTION

### 1. Technical Field

The present invention relates to the field of medical diagnosis and prediction imaging systems, and more particularly, to generation of synthetic blood vessel and lesion training data for deep neural networks (DNNs) to improve diagnosis and prediction.

### 2. Discussion of Related Art

Automatic vessel and lesion segmentation has diverse benefits including improved computer aided diagnosis, planning and treatment of liver cancer. For example, artificial intelligence (AI) methods such as neural networks (NN) and especially deep neural networks (DNN) may be applied to detect (segment) vessels, e.g., for surgical planning and computer-aided diagnosis, yet require a bulk of training data such tissue images which must be painstakingly annotated by experts to detect blood vessels in them (which is difficult to achieve accurately because of the complex 3D structure and low image quality involved)—so that the DNN may be trained for vessel and/or lesion segmentation based on the annotated real-life images. Moreover, better DNN vessel and/or lesion segmentation reduces the number of actual images (e.g., CT/MRI) that are required for operation planning, reducing patient exposure, and involved time and costs.

### SUMMARY OF THE INVENTION

The following is a simplified summary providing an initial understanding of the invention. The summary does not necessarily identify key elements nor limit the scope of the invention, but merely serves as an introduction to the following description.

One aspect of the present invention provides a system for generating synthetic training data for blood vessels and/or lesion segmentation, the system comprising: a parametric blood vessel branching simulation module configured to generate a 3D vessel model and/or a parametric lesion simulation module configured to generate a 3D lesion model, and an augmentation module configured to add noise, background and organ boundaries to the 3D vessel and/or lesion models, to yield the synthetic training data. One aspect of the present invention provides a DNN training system configured to train DNNs using the generated synthetic training data.

One aspect of the present invention provides a method of generating synthetic training data for blood vessels and/or lesion segmentation, the method comprising: generating a 3D vessel and/or lesion model(s) using a parametric blood vessel branching simulation and/or a parametric lesion simulation module, and adding a background and optionally noise and/or organ boundaries to the generated 3D vessel and/or lesion models. One aspect of the present invention provides a DNN training method configured to train DNNs using generated synthetic training data from the 3D vessel and/or lesion models.

One aspect of the present invention provides a computer program product comprising a non-transitory computer readable storage medium having computer readable program embodied therewith, the computer readable program comprising: computer readable program configured to generate a 3D vessel model using a parametric blood vessel branching simulation and/or computer readable program configured to generate a 3D lesion model using a parametric lesion simulation, and computer readable program configured to add a background and optionally noise and/or organ boundaries to the generated 3D vessel and/or models. One aspect of the present invention provides a provides a computer program product comprising a non-transitory computer readable storage medium having computer readable program embodied therewith, the computer readable program comprising computer readable program configured to train a deep neural network using generated synthetic training data from the 3D vessel and/or lesion models.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout. The patent or application file contains several drawings executed in color. Copies of this patent or patent application publication with color drawing(s) will be provided by the Office upon request and payment of the necessary fee. In the accompanying drawings:

FIG. 1 is a high-level schematic block diagram of a DNN training system and a system for generating synthetic training data for blood vessels segmentation, according to some embodiments of the invention.

FIGS. 2A-2F provide non-limiting examples for the generation of synthetic training data for blood vessels segmentation, according to some embodiments of the invention.

FIG. 3 is a high-level flowchart illustrating a method of generating synthetic training data for blood vessels segmentation, according to some embodiments of the invention.

FIG. 4 is a high-level block diagram of exemplary computing device, which may be used with embodiments of the present invention.

FIGS. 5A and 5B illustrate schematically the training of a DNN by the training module using the augmented 3D model, according to some embodiments of the invention.

FIGS. 6A-6D provide an evaluation of the quality of disclosed training using the augmented 3D model, according to some embodiments of the invention.

FIG. 7 provides non-limiting examples for synthetically generated lesions by the parametric lesion simulation module used for the 3D lesion model, according to some embodiments of the invention.

FIGS. 8A and 8B provide non-limiting examples for synthetically generated lesions, augmented by multi-contrast phase (CP), according to some embodiments of the invention.

FIGS. 9A and 9B provide non-limiting examples for successful DNN lesion segmentation based on qualitative validation by experts, which was achieved by DNNs trained on the synthetic images in segmenting tumors and necrosis, respectively, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein are for the purpose of description and should not be regarded as limiting.

Unless specifically stated otherwise, as apparent from the following discussions, it is appreciated that throughout the specification discussions utilizing terms such as “processing”, “computing”, “calculating”. “determining”, “enhancing”, “deriving” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention provide efficient and economical methods and mechanisms to train deep neural networks (DNN) for vessel and/or lesion segmentation and thereby provide improvements to the technological field of vessel segmentation. Systems and methods for training deep neural networks (DNNs) for blood vessel and lesion segmentation using synthetically generated training data, are provided. Systems may comprise parametric simulation modules for generating 3D branching blood vessels and 3D lesion structures and an augmentation module configured to add noise, background and organ boundaries to the 3D models, to yield the synthetic training data for training the DNNs. The 3D vessel model may be generated as a hierarchical tree comprising segments that are generated as anti-aliased lines with specified length and start and end thicknesses, which are elongated by segment addition(s) and/or by branching to follow semi-linear or curved lines, while avoiding overlapping of segments. The 3D lesion model and/or combined vessel/lesion models may be generated using multiple input images such as contrast enhancement phases.

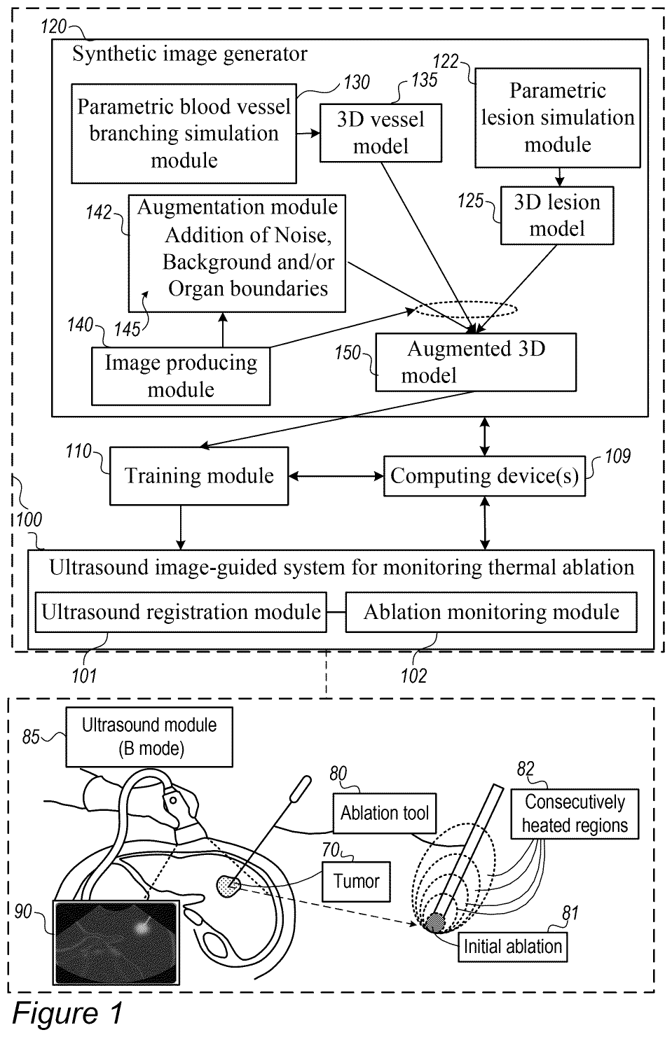

FIG. 1 is a high-level schematic block diagram of a DNN training system 100 and a system 120 for generating synthetic training data for blood vessels segmentation, according to some embodiments of the invention. System 120 comprises a parametric blood vessel branching simulation module 130 configured to generate a 3D vessel model 135, and an image producing module 140 configured to generate images, and associated with and/or comprising an augmentation module 142 configured to add various additions and augmentations 145 (e.g., background, noise and/or other artefacts, organ boundaries, vessel textures, etc.) to 3D vessel model 135, to yield an augmented 3D model 150 that is used to provide the synthetic training data. For example, augmented 3D model 150 may comprise 3D tensors that represent vessels and/or lesions and correspond to one or more contrast phase. Cross sectional images may be derived from augmented 3D model 150 for visualization, and model 150 may be used to train DNNs as disclosed herein. The integration of vessel and/or lesion models and their augmentation, carried out by image producing module 140, is indicated schematically by the broken ellipse in FIG. 1.

For example, parametric blood vessel branching simulation module 130 may be configured to generate 3D vessel model 135 as a hierarchical tree 160 comprising a plurality of segments 165. Segments 165 may be generated as anti-aliased lines, each having a specified length and specified start and end thicknesses, wherein the anti-aliasing is carried out by selecting a limited number of random samples such that multiple samples end up in each voxel within the segment, and wherein the specified end thickness is equal or smaller than the specified start thickness. For example, segment generation may include filling of 3D voxels that are within the parametric volume (e.g., cylinder or capped cones) that is defined by the segment start end and thickness. The filling may be carried out by random samples which result in non-smooth surfaces. Segments 165 may then be elongated by addition and/or branching. Addition may be carried out by adding a new segment to an existing segment, wherein the added segment has a specified start thickness that is equal or smaller than the specified end thickness of the existing segment that is elongated. Branching may be carried out by branching an existing segment into two (or more) segments having equal or smaller thickness than the existing segment that is branched. Strings of branched segments may be configured to follow semi-linear or curved lines (e.g., of branched segments with respect to existing segments), mimicking natural vessel elongation and branching. For example, when a new branch is created its direction is inherited from its parent segment and may be randomly adjusted. e.g., by combining a purely random component and a component that is derived from the curvature parameter of the segments string preceding the new branch. Segments 165 may be configured not to overlap during initiation, elongation and branching thereof, with specific rules implemented to prevent overlaps.

In certain embodiments, system 120 may comprise a parametric lesion simulation module 122 configured to generate a 3D lesion model 125, with image producing module 140 configured to generate images, and associated with and/or comprising augmentation module 142 configured to add various additions and augmentations 145 (e.g., background, noise and/or other artefacts, organ boundaries, vessel textures, etc.) to 3D lesion model 125, to yield an augmented 3D model 150 that provides the synthetic training data.

In certain embodiments, system 120 may comprise both parametric blood vessel branching simulation module 130 configured to generate 3D vessel model 135 and parametric lesion simulation module 122 configured to generate a 3D lesion model 125—with image producing module 140 configured to generate combined images, including both vessel and lesion segmentations.

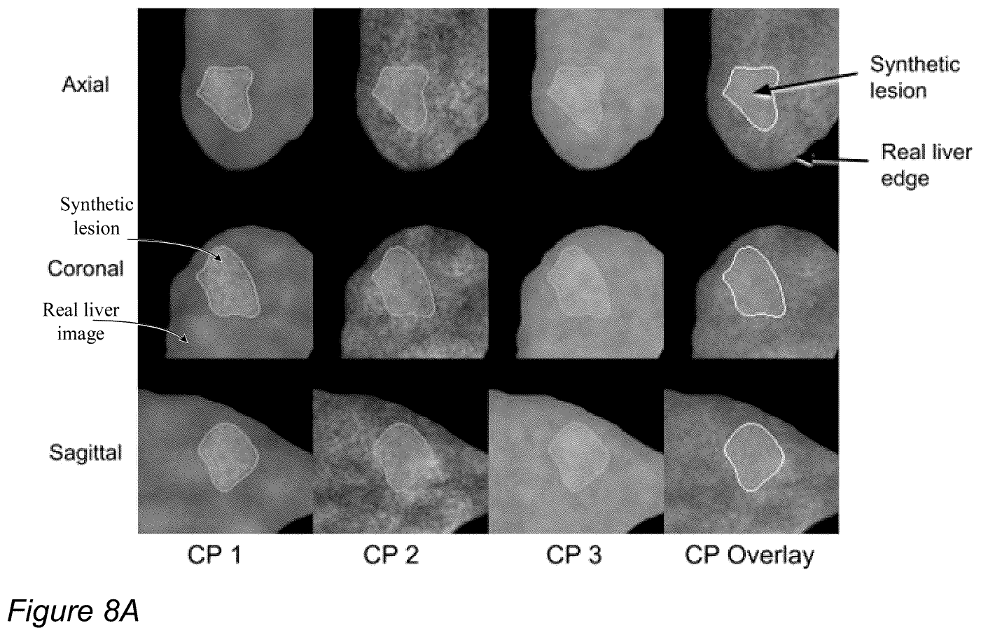

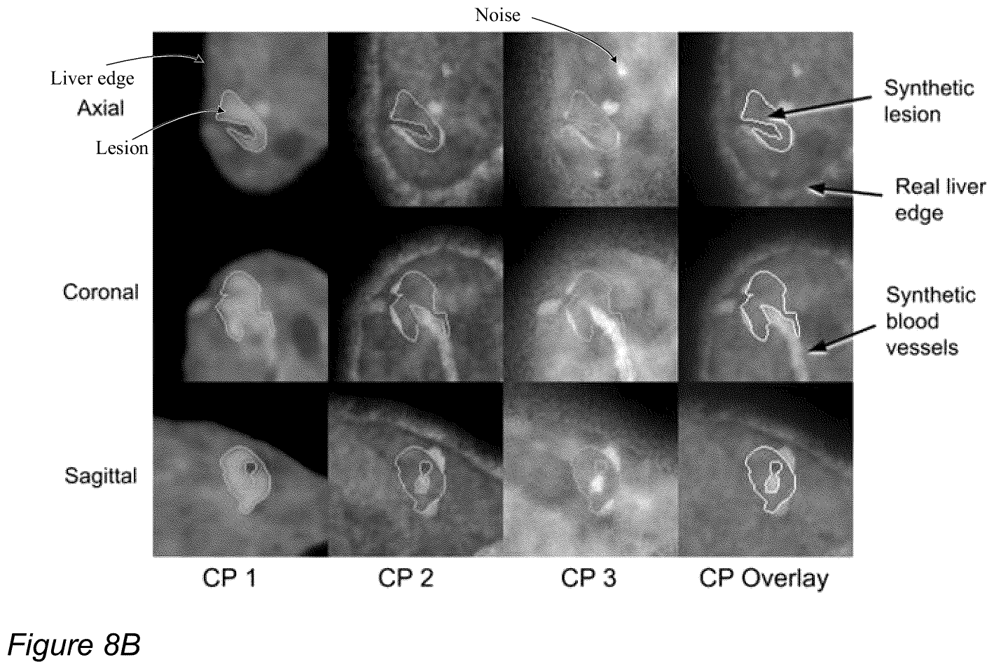

Lesion position and structure may be generated by parametric lesion simulation module 122, with which the vessel model may be combined, followed by optional addition of noise (e.g., small lesion-like structures) and background. The multiple elements may be combined, e.g., by modifying the intensity of the underlying background or by blending a noisy texture image. Lesion generation may be carried out in multiple phases, and in each of the phases—lesions, vessels and optionally noise, background and organ boundaries may be combined to yield respective phase-specific models—which may then be integrated to yield the model used for training the DNN (see examples in FIGS. 8A and 8B).

Merging of structures (e.g., vessels, lesions, noise, etc.) may be carried out by modifying the intensity of the underlying background and/or by blending a noisy texture image.

DNN training system 100 may further comprise a DNN training module 110 configured to receive augmented 3D model 150 and use it to train DNNs for blood vessel and/or lesion segmentation (instead of using manually annotated real images or real images with computer-generated annotations). DNN training system 100 is configured to train DNN for blood vessel and/or lesion segmentation using the synthetic training data generated by synthetic model generator 120.

For example, at train time, each training sample may be provided as a combination of three 3D images, with each of the 3D images being based on the same vessels and/or lesions structures but with different augmentations. At inference time, the input to the DNN may also include three 3D images, with each 3D image being from a different contrast phase—corresponding to a different duration between the scan time of the tissue and time of injecting the contrast agent. In some embodiments, if fewer than three contrast phases are available, one of the contrast phases may be duplicated to provide the input image data.

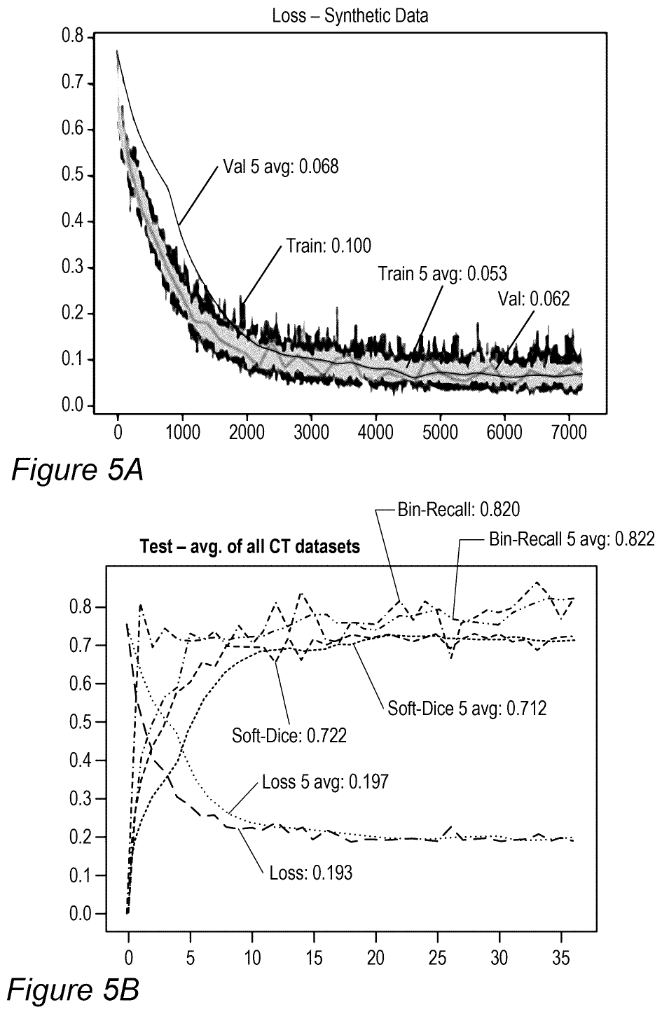

Non-limiting examples for a training process are provided in FIGS. 5A and 5B below. In certain embodiments. DNN training module 110 may further incorporate real data 90 (e.g., liver segmentation) as addition to the training with synthetic data from augmented 3D model 150. The real data may be added to modify augmented 3D model 150 and/or be used as an additional data source to carry out the training. Both combining real and synthetic data, and training on a mix of real and synthetic data may be advantageous with respect to the accuracy of the resulting DNN, and/or the DNN may be re-trained by transfer learning—e.g., using real data to further train at least some of the parameters of the DNN. Especially if the extent of real data is much smaller than the extent of synthetic data, real data may be used to train the DNN in crucial or ambiguous parameters beyond the training with synthetic data. For example, in initial experiments, a small number (under one hundred) of real liver segmentations could be used for training the DNN by masking out synthetic voxels outside of the real liver segmentation.

3D vessel model 135 and augmented 3D model 150 may simulate real images of blood vessels—using various modalities (e.g., CT. MRI or other) and relating to different organs (e.g., liver, lungs or other). While the examples presented herein relate to simulating CT and MR images of blood vessels in the liver, the disclosed systems and methods are not limited by these examples, and can be implemented in other imaging modalities and for vessels of different organ systems. Disclosed systems and methods are applicable and robust to a wide range of imaging modalities including CT, MR and 3D ultrasound—used as input and/or provided as output. When used as input data for the DNN, 3D ultrasound may be obtained by a 3D probe (currently in low quality) and/or constructed as a 3D (volume) reconstruction of 2D images obtained by a sweeping or panning motion of a 2D probe.

Systems 100, 120, training module 110 and/or parts thereof may be implemented by computing device(s) 109 described in further detail in FIG. 4 below.

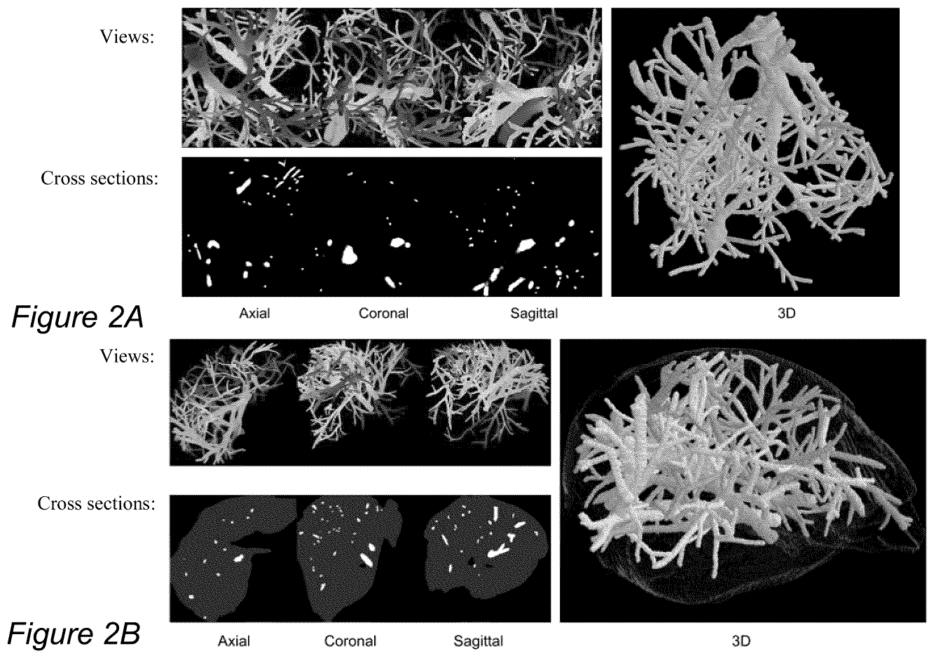

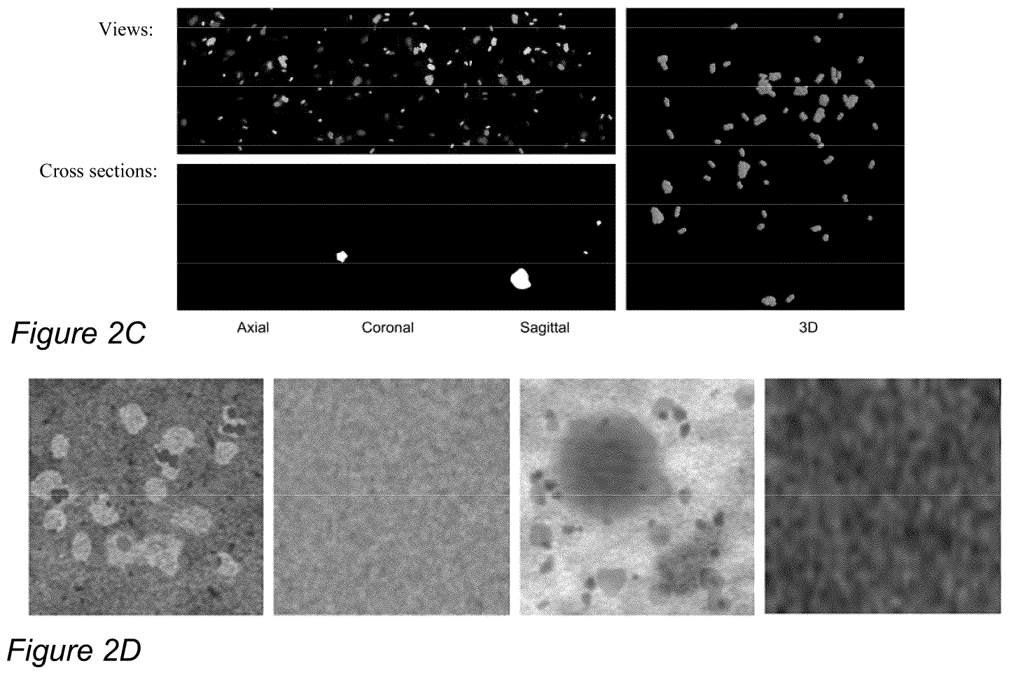

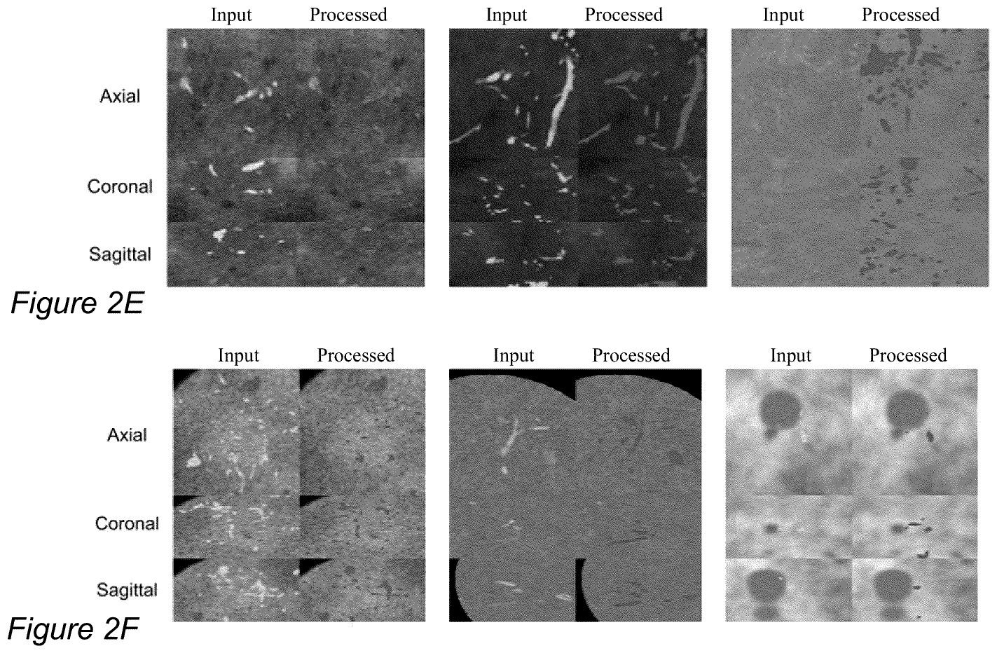

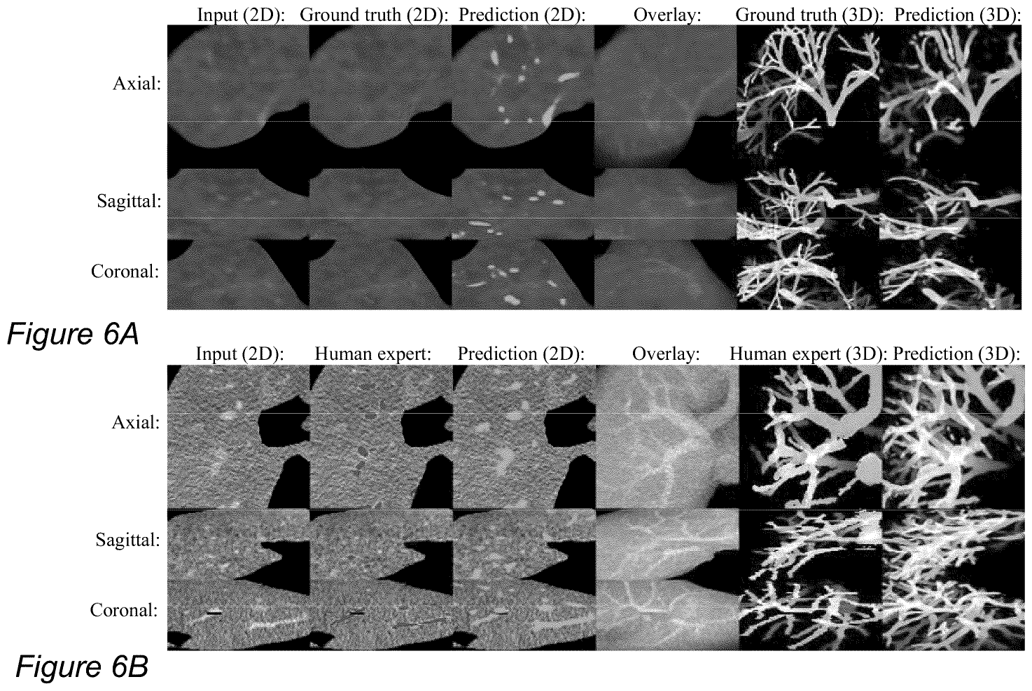

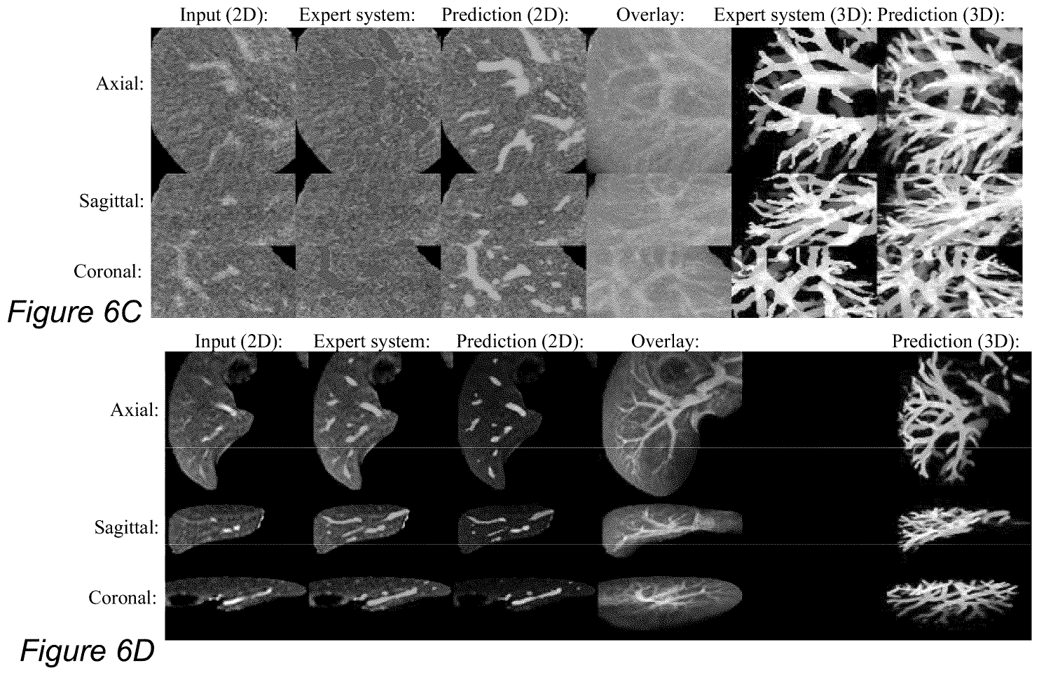

FIGS. 2A-2F provide non-limiting examples for the generation of synthetic training data for blood vessels segmentation, according to some embodiments of the invention. FIGS. 2A and 2B illustrate examples for synthetic vessel images in 3D view (color coded by vessel identity), in axial, coronal and sagittal views (color coded by distance from the image plane) and in axial, coronal and sagittal cross sections. FIGS. 2A and 2B provide two different, non-limiting examples of different artificially generated vessel configurations, out of an infinite number of possibilities that can be generated by the algorithm. FIG. 2C illustrates a non-limiting example of a noise pattern 145A that may be used to augment 3D vessel model 135 to yield augmented 3D model 150, with the noise generated randomly (e.g., as very short vessel structures or segments) and illustrated in schematic 3D view, in axial, coronal and sagittal views (color coded by distance from the image plane) and in axial, coronal and sagittal cross sections. FIG. 2D illustrates non-limiting examples of background images 145B that may be used to augment 3D vessel model 135 to yield augmented 3D model 150. The background images may be generated synthetically. e.g., with respect to specific tissue characteristics, or possibly using typical real-tissue images of the respective tissue type (preferably lacking blood vessels to avoid mismatches with artificially added vessels). The examples are shown in the axial cross section. Merging noise 145A and background 145B information and augmenting 3D vessel model 135 to yield augmented 3D model 150 may be carried out in different orders (e.g., first merging the noise pattern with the vessel pattern, first merging the noise with the background, or by any other order). Organ boundaries 145C may be applied as a mask over the merged augmented model and/or over images derived therefrom, as illustrated e.g., in FIGS. 2E and 2F which provide multiple merged images in axial, coronal and sagittal cross sections, which include the input images and processed imaged that include algorithmically generated vessels with added noise 145A and background 145C, and with additional augmentation (in red). It is noted that FIG. 6A-6D below also includes vessel identified during the training, indicating the high accuracy achieved by training on the disclosed artificial vessel structures. Additional types of augmentation 145 may include vessel texture (e.g., derived by blending a predefined textured volume using the vessels as the blend mask), as well as artefacts added on top of the augmented model such as additional noise and/or blurring.

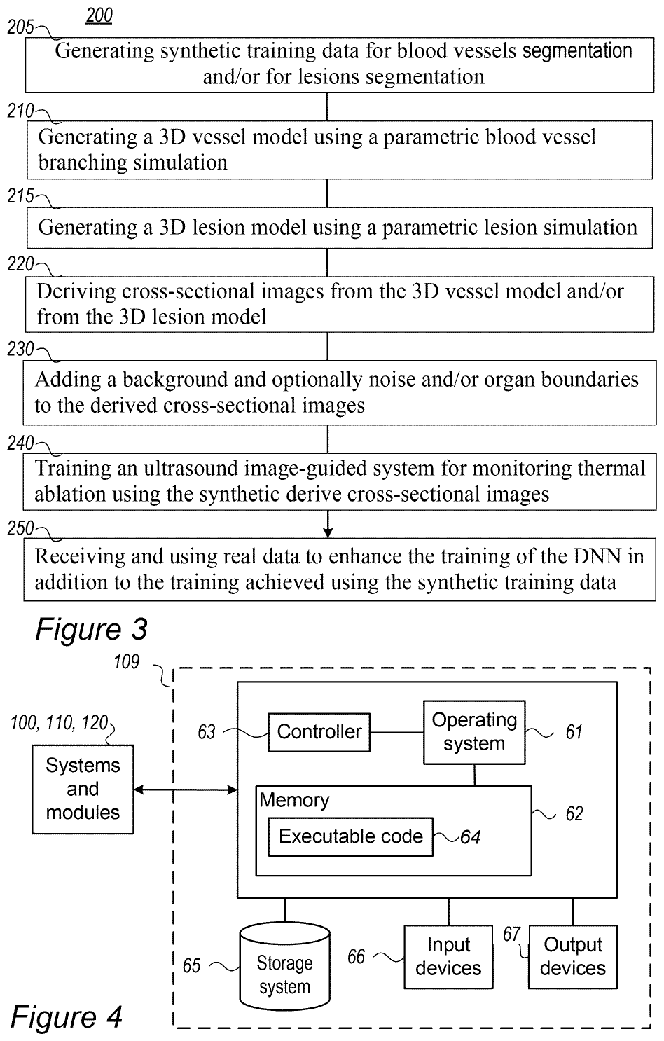

FIG. 3 is a high-level flowchart illustrating a method 200 of generating synthetic training data for blood vessels segmentation, according to some embodiments of the invention. The method stages may be carried out with respect to systems 100, 120 described above, which may optionally be configured to implement method 200. Method 200 may be at least partially implemented by at least one computer processor. e.g., computing device(s) 109 associated with any of systems 120, 110, 100 and/or module 110. Certain embodiments comprise computer program products comprising a non-transitory computer readable storage medium having computer readable program embodied therewith and configured to carry out the relevant stages of method 200. Method 200 may comprise the following stages, irrespective of their order.

Method 200 comprises generating synthetic training data for blood vessels and/or for lesions segmentation (stage 205), comprising, e.g., generating a 3D vessel model using a parametric blood vessel branching simulation (stage 210) and/or generating a 3D lesion model using a parametric lesion simulation (stage 215, optionally generated using multiple image phases); and adding a background and optionally noise and/or organ boundaries to the generated 3D vessel model (stage 230). The 3D vessel model may be generated as a hierarchical tree comprising a plurality of segments, as explained below. Method 200 may further comprise deriving cross-sectional images from the 3D vessel model and/or from the 3D lesion model (stage 220) and training a deep neural network for blood vessel and/or lesion segmentation (stage 240) using the respective images.

In certain embodiments, method 200 may further comprise receiving and using real data to enhance the training of the DNN in addition to the training achieved using the synthetic training data (stage 250), e.g., in a combined training dataset and/or using real data after the training using the synthetic data—to enhance the accuracy of specific parameters or the accuracy of the model as a whole.

Method 200 may further comprise generating the segments of the simulated vessels as anti-aliased lines, with each segment having a specified length and specified start and end thicknesses. The anti-aliasing may be carried out by selecting a limited number of random samples such that multiple samples end up in each voxel within the segment, wherein the specified end thickness is equal or smaller than the specified start thickness. Method 200 may further comprise elongating the segments of the simulated vessels by at least one of: addition of a segment having a specified start thickness that is equal or smaller than the specified end thickness of the segment that is elongated, and/or branching into two segments having equal or smaller thickness than the segment that is branched, wherein a string of branched segments follows a semi-linear or a curved line. During the generation of the hierarchical tree, the segments may be kept non-overlapping.

Advantageously, disclosed systems 100, 120 and methods 200 generate fully synthetic training data comprising high-resolution vessel and/or lesion segmentation images without human supervision—which were shown to be at least as effective for training DNN systems as are real-life training data that was annotated by human (see FIGS. 6A-6D). Disclosed systems 120 and methods 200 therefore provide solutions for the crucial task of training DNN for vessel and/or lesion segmentation. The trained DNN may then be used for surgical planning and computer-aided diagnosis, e.g., of liver tissue, and of other tissue types. Correct vessel segmentation is crucial for procedures such as biopsy, thermal ablation and selective internal radiation therapy (SIRT), in which correct vessel patient specific modelling (PSM) helps to avoid bleeding when inserting needles or other surgical implements, and reduce radiation exposure due to enhanced accuracy and sensitivity of vessel segmentation. Correct lesion segmentation is crucial for establishing the effects of ablation procedures, in real time and/or after treatment, to verify efficient treatment. Additional applications of lesion segmentation include monitoring the progression of lesion formation (Lesion progression monitoring), e.g., analyzing lesion growth over time and/or volumetric lesion measurements for planning various treatments and procedures (e.g., ablation, surgery, irradiation, chemotherapy, biopsy, etc.).

Corresponding computer readable program (see, e.g., executable code 64 in FIG. 4 below) may comprise one or more of the following, or part(s) thereof; computer readable program configured to generate a 3D vessel model using a parametric blood vessel branching simulation, computer readable program configured to generate a 3D lesion model using a parametric lesion simulation, and computer readable program configured to add a background and optionally noise and/or organ boundaries to the generated 3D vessel and/or lesion model. The computer program product may further comprise computer readable program configured to generate the segments of the vessel model as anti-aliased lines, each having a specified length and specified start and end thicknesses, wherein the anti-aliasing is carried out by selecting a limited number of random samples such that multiple samples end up in each voxel within the segment, and wherein the specified end thickness is equal or smaller than the specified start thickness. The computer program product may further comprise computer readable program configured to elongate the segments of the lesion model by at least one of: addition of a segment having a specified start thickness that is equal or smaller than the specified end thickness of the segment that is elongated, and/or branching into two segments having equal or smaller thickness than the segment that is branched, wherein a string of branched segments follows a semi-linear or a curved line, wherein the segments are non-overlapping. The computer program product may further comprise computer readable program configured to train a deep neural network for blood vessel and/or lesion segmentation. The computer program product may further comprise computer readable program configured to receive and use real data to enhance the training of the DNN in addition to the training achieved using the synthetic training data.

FIG. 4 is a high-level block diagram of exemplary computing device 109, which may be used with embodiments of the present invention. Computing device 109 may include a controller or processor 63 that may be or include, for example, one or more central processing unit processor(s) (CPU), one or more Graphics Processing Unit(s) (GPU or general purpose GPU-GPGPU), a chip or any suitable computing or computational device, an operating system 61, a memory 62, a storage 65, input devices 66 and output devices 67. Any of systems 120, 100 and/or module 110 may comprise at least parts of the computer system as shown for example in FIG. 4. Computer program products may comprise a computer readable storage medium such as memory 62 and/or storage 65, having computer readable program embodied therewith (e.g., executable code 64) and configured to carry out the relevant stages of method 200.

Operating system 61 may be or may include any code segment designed and/or configured to perform tasks involving coordination, scheduling, arbitration, supervising, controlling or otherwise managing operation of computing device 109, for example, scheduling execution of programs. Memory 62 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short-term memory unit, a long-term memory unit, or other suitable memory units or storage units. Memory 62 may be or may include a plurality of possibly different memory units. Memory 62 may store for example, instructions to carry out a method (e.g., code 64), and/or data such as user responses, interruptions, etc.

Executable code 64 may be any executable code, e.g., an application, a program, a process, task or script. Executable code 64 may be executed by controller 63 possibly under control of operating system 61. For example, executable code 64 may when executed cause the production or compilation of computer code, or application execution such as VR execution or inference, according to embodiments of the present invention. Executable code 64 may be code produced by methods described herein. For the various modules and functions described herein, one or more computing devices 109 or components of computing device 109 may be used. Devices that include components similar or different to those included in computing device 109 may be used, and may be connected to a network and used as a system. One or more processor(s) 63 may be configured to carry out embodiments of the present invention by for example executing software or code.

Storage 65 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data such as instructions, code, VR model data, parameters, etc. may be stored in a storage 65 and may be loaded from storage 65 into a memory 62 where it may be processed by controller 63. In some embodiments, some of the components shown in FIG. 4 may be omitted.

Input devices 66 may be or may include for example a mouse, a keyboard, a touch screen or pad or any suitable input device. It will be recognized that any suitable number of input devices may be operatively connected to computing device 109 as shown by block 66. Output devices 67 may include one or more displays, speakers and/or any other suitable output devices. It will be recognized that any suitable number of output devices may be operatively connected to computing device 109 as shown by block 67. Any applicable input/output (I/O) devices may be connected to computing device 109, for example, a wired or wireless network interface card (NIC), a modem, printer or facsimile machine, a universal serial bus (USB) device or external hard drive may be included in input devices 66 and/or output devices 67.

Embodiments of the invention may include one or more article(s) (e.g., memory 62 or storage 65) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

Elements from FIGS. 1-4 may be combined in any operable combination, and the illustration of certain elements in certain figures and not in others merely serves an explanatory purpose and is non-limiting.

FIGS. 5A and 5B illustrate schematically the training of a DNN by training module 110 using augmented 3D model 150, according to some embodiments of the invention. As a verification procedure, a modified UNET3D (three dimensional U-shaped networks) architecture was applied as the DNN to segment blood vessels augmented 3D model 150. The modifications of the UNET3D algorithm included replacing the max pooling with convolutions, and applying deconvolution and skip-connections for all resolution levels. The network was modeled with 513 million parameters and the loss functions included combined Soft Dice and Binary Cross Entropy loss functions and an Adam optimizer with a learning rate decay. FIGS. 5A and 5B illustrate the effective training of the network and the effectivity of the using the loss functions. FIG. 5A provides the loss (as the sum of the Soft Dice and Binary Cross Entropy losses) as a function of the number of training iterations for the training dataset and for a validation dataset (which is generated identically to the training dataset and is much smaller). The graphs are provided in raw and smoothed (as averages of five datapoints) versions. The loss for the training data approaches 0.10 (0.05 for smoothed data) and the loss for the validation data 0.62 (0.68 when smoothed). FIG. 5B provides the loss (as the sum of the Soft Dice and Binary Cross Entropy losses) as a function of the number of validation iterations for all the test datasets, which include real CT images annotated by human experts (see, e.g., FIG. 6B). The graphs are provided in raw and smoothed (as averages of five datapoints) versions. The loss (the sum of the Soft Dice and Binary Cross Entropy losses) approaches 0.193 (0.197 for smoothed data) and the Soft Dice loss approaches 0.722 (0.712 when smoothed). The Bin-Recall provides a measure for verifying that the system detected all real vessels. It is noted that as the system may detect vessels that are not identifiable by a person (possibly over-performing human experts), it may seem not to reach high overlap scores. The Bin-Recall approaches 0.820 (0.822 when smoothed). Bin refers to binarization of the segmentation output probabilities (threshold 0.5).

FIGS. 6A-6D provide an evaluation of the quality of disclosed training using augmented 3D model 150, according to some embodiments of the invention. The evaluation includes validation of the DNN training (FIG. 6A) and comparisons of the training results of the DNN trained by training module 110 to results of vessel segmentation carried out by human-experts (FIG. 6B) and to results of vessel segmentation carried out automatically by an expert system that was trained on real-life images labeled by human experts, for CT (FIG. 6C) and for MRI (FIG. 6D). The evaluation clearly shows the validity of the disclosed approach as well as its exceptional performance, as the DNN trained by training module 110 is shown to identify all the vessels which were also identified by human experts and prior art automated systems, and moreover, were able to identify vessels that were beyond the identification ability of human experts.

In FIGS. 6A-6D, axial, coronal and sagittal cross sections (2D middle slices) are provided from left to right for: the real-life input images, the reference ground truth (FIG. 6A), human expert (FIG. 6B) or automated (FIGS. 6C and 6D) vessel segmentation in 2D, the prediction by the trained DNN, their overlay and the resulting color-coded segmentation (3D depth images, with red for close to the image plane, blue for far from the image plane) for the reference human/machine segmentation and for the trained DNN segmentation.

FIG. 6A illustrates the validation test of the DNN training, derived by comparing the segmentation results by the trained DNN to the ground truth on synthetic data (namely the vessel labels of the synthetic data, as generated by 3D vessel model 135 prior to the addition of background and optionally noise and/or organ boundaries). The validation was carried out for data which were not used for training the DNN.

In all comparisons (FIGS. 6B-6D), trained DNN results are compared to results from other expert sources (human or machine) based on real-life CT images. FIG. 6B provides a comparison of results of vessel segmentation applied by the trained DNN with segmentations performed by human experts on real-life CT images from the IRCAD dataset (L'Institut de recherche contre les cancers de l'appareil digestif, see www. https://www.ircad.fr). FIG. 6C provides a comparison of results by disclosed models (denoted as “predictions”), compared to vessel segmentation applied by a different DNN, developed and published by Fraunhofer research institute, and trained using segmentations performed by human experts assisted by semi-automatic segmentation tools to real-life CT images. FIG. 6D provides the results by disclosed models (denoted as “predictions”) on real-life MRI images.

FIGS. 6A-6D illustrate that the performance of the trained DNN (trained by disclosed system 100) is similar or better to dedicated software in detecting the vessels on the real images. The trained DNN was able to segment correctly almost all the vessels that were annotated by human experts, and moreover, the trained DNN was able to detect (segment) a significant number of finer vessels that were not identified by the human experts.

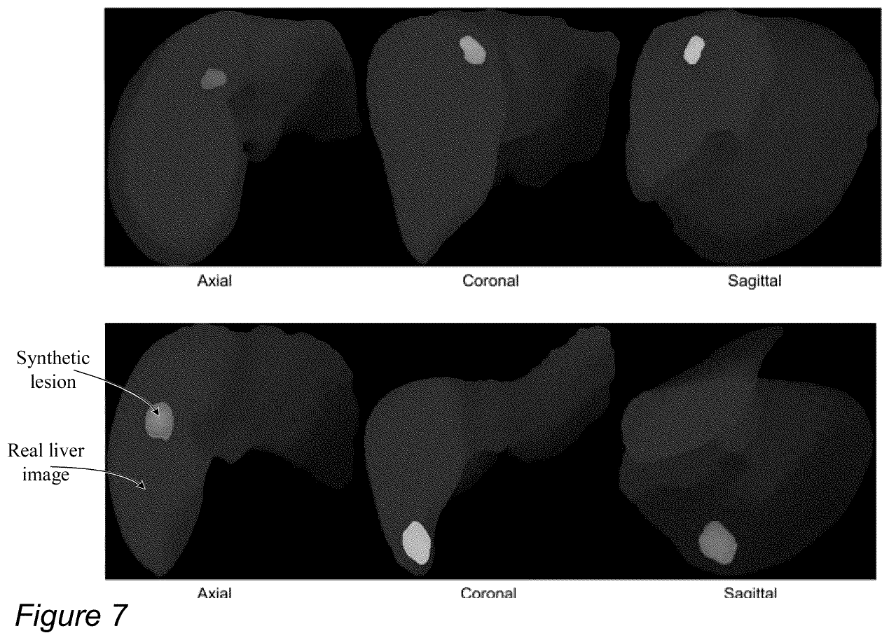

FIG. 7 provides non-limiting examples for synthetically generated lesions by parametric lesion simulation module 122 used for 3D lesion model 125, according to some embodiments of the invention. The synthetic lesions are generated within real liver images, with the positions and structures of the synthetic lesions inferred from the images (optionally including reference to the surrounding of the structure—referred to as padding). For example, the training data may be generated so that the lesion center is close to the center of the input volume and its size relative to the input volume is within a constant range (e.g., padding of 80%-120% relative to lesion diameter in each direction). At inference time, a bounding box around the lesion may be entered (e.g., by a physician or a technician, or possibly by a model) so that the volume can be cropped and resized such that it is within the variability of the training data. In certain embodiments it is sufficient to mark a 2D bounding box on a lesion slice close to the lesion center in the orthogonal dimension—to enable the derivation of the lesion.

FIGS. 8A and 8B provide non-limiting examples for synthetically generated lesions, augmented by multi-contrast phase (CP), according to some embodiments of the invention. Synthetic lesions are shown within real liver images at multiple contrast phases, and the generated 3D lesion model 125 may comprise an overlay of the lesions at multiple contrast phases. The different contrast phases may comprise plain images of various types, added noise (see, e.g., FIG. 8B) and added synthetic vessels from 3D synthetic vessel model 135 (see, e.g., FIG. 8B) to provide histologically realistic lesion models for training the DNN. The multiple phases may be combined by parametric lesion simulation module 122 (e.g., when concerning the lesions themselves), by augmentation module 142 (e.g., when concerning additions such as noise) and/or by image producing module 140 (e.g., when concerning combining lesion and vessel models).

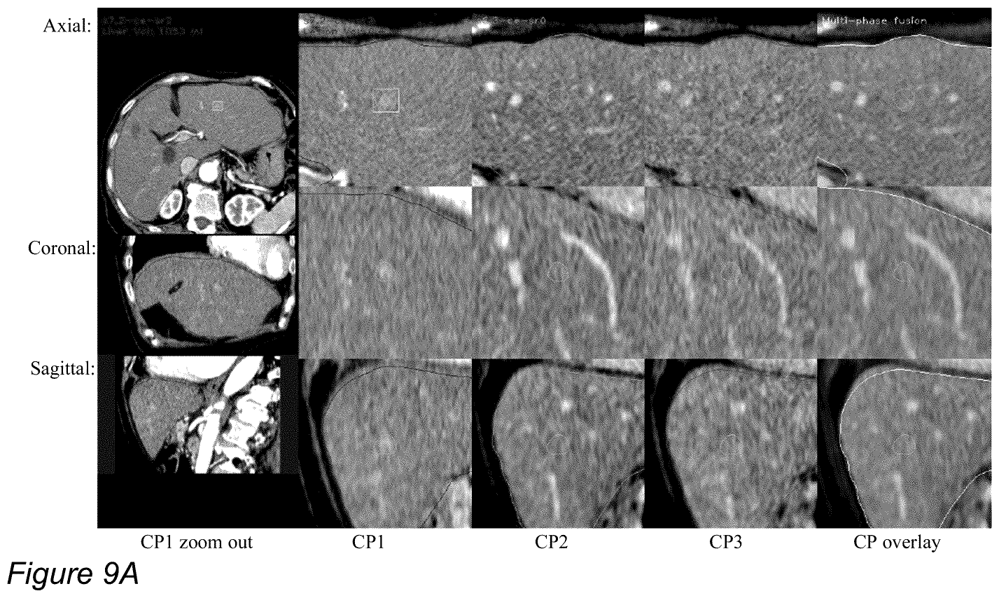

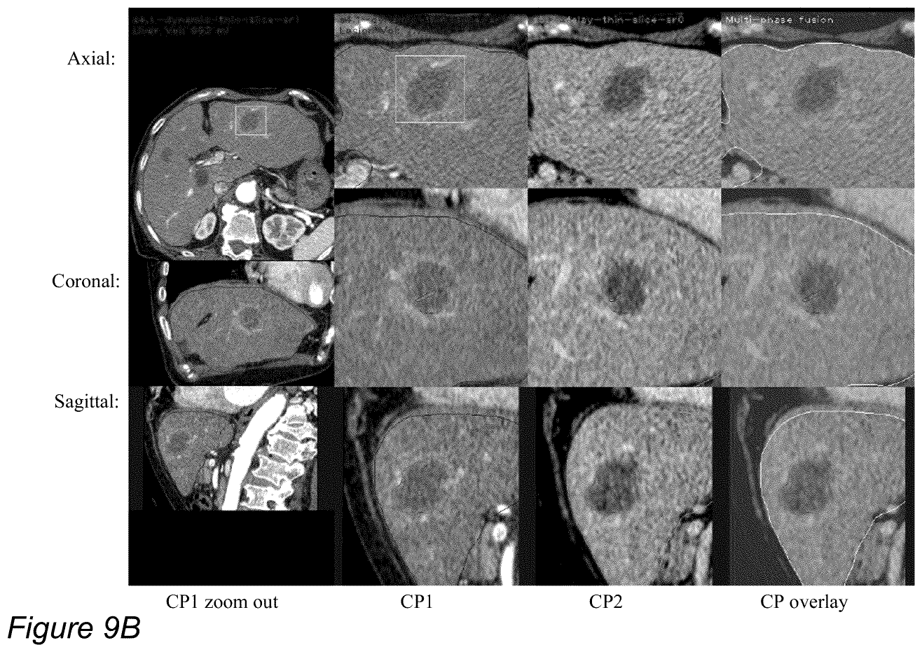

FIGS. 9A and 9B provide non-limiting examples for successful DNN lesion segmentation based on qualitative validation by experts, which was achieved by DNNs trained on the synthetic images in segmenting tumors and necrosis, respectively, according to some embodiments of the invention. The figures provide axial, coronal and sagittal cross sections for three contrast phases (CPs) in FIG. 9A and two contrast phases (CPs) in FIG. 9B, as well as overview (zoom out) images and overlay images providing the respective composite images—indicated the applicability of the trained DNN and the effectivity of disclosed systems and methods.

The clinical contribution of disclosed models has multiple aspects, including improved segmentation and greater accuracy for applications such as: liver surgical planning and computer-aided diagnosis, selective internal radiation therapy (SIRT), avoidance of bleeding when inserting needles into tissue (e.g., for ablation or biopsy), reduction of radiation exposure and provision of accurate registration between different image modalities (e.g., CT-MRI and multi contrast phase fusion). For example, disclosed embodiments may improve needle path planning for liver surgical procedures such as biopsy and thermal ablation. Specifically, disclosed lesion segmentation may be used to optimize the definition and detection of the needle target and/or disclosed vessels segmentation may be used to select a needle insertion path that minimizes the damage to vessels surrounding the target.

Advantageously, disclosed systems and methods were shown to enable training of deep neural networks (DNN) to detect real vessels that are difficult for an expert to detect. In certain embodiments, the automated vessel segmentation may be configured to incorporate expert annotations. e.g., to improve the accuracy of the system. In certain embodiments, disclosed systems and methods may be configured to annotate high and/or low quality CT (low quality CT may also be used to test the DNN).

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram or portions thereof.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram or portions thereof.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram or portions thereof.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the invention. The various appearances of “one embodiment”. “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A system for generating synthetic training data for blood vessels and/or lesions segmentation, the system comprising:
a parametric blood vessel branching simulation module configured to generate a 3D vessel model and/or a parametric lesion simulation module configured to generate a 3D lesion model, and
an augmentation module configured to add a background to the respective 3D vessel model and/or lesion model, to yield the synthetic training data.

2. The system of claim 1, wherein the augmentation module is further configured to add noise and organ boundaries to the 3D vessel model and/or lesion model, to yield the synthetic training data.

3. The system of claim 1, wherein:
the system comprises the parametric blood vessel branching simulation module, which is configured to generate the 3D vessel model as a hierarchical tree comprising a plurality of segments,
the segments are generated as anti-aliased lines, each having a specified length and specified start and end thicknesses, wherein the anti-aliasing is carried out by selecting a limited number of random samples such that multiple samples end up in each voxel within the segment, and wherein the specified end thickness is equal or smaller than the specified start thickness,
the segments are elongated by at least one of:
addition of a segment having a specified start thickness that is equal or smaller than the specified end thickness of the segment that is elongated, and/or
branching into two segments having equal or smaller thickness than the segment that is branched, wherein a string of branched segments follows a semi-linear or a curved line, and
the segments are non-overlapping.

4. The system of claim 1, comprising the parametric lesion simulation module.

5. The system of claim 4, wherein the augmentation module is further configured to add the 3D vessel model to the 3D lesion model, to yield the synthetic training data.

6. The system of claim 4, wherein the augmentation module is further configured to add noise and organ boundaries to the 3D lesion model, to yield the synthetic training data.

7. The system of claim 4, further configured to generate the 3D lesion model using multiple image phases.

8. The system of claim 1, further configured to train a deep neural network (DNN) using the synthetic training data.

9. A DNN training system configured to train a DNN for blood vessel and/or lesion segmentation using the synthetic training data generated by the system of claim 1.

10. The DNN training system of claim 9, further configured to receive real data and use the real data to enhance the training of the DNN using the real data in addition to the synthetic training data.

11. The DNN training system of claim 9, further configured to use the real data together with the synthetic training data for the training of the DNN.

12. The DNN training system of claim 9, further configured to use the real data to improve the training of the DNN.

13. A method of generating synthetic training data for blood vessels and/or lesions segmentation, the method comprising:
generating a 3D vessel model using a parametric blood vessel branching simulation and/or generating a 3D lesion model using a parametric lesion simulation, and
adding a background to the generated 3D vessel model and/or lesion model.

14. The method of claim 13, further comprising adding noise and/or organ boundaries to the generated 3D vessel and/or lesion model

15. The method of claim 13, comprising generating the 3D vessel model as a hierarchical tree comprising a plurality of segments, and the method further comprises:
generating the segments as anti-aliased lines, each having a specified length and specified start and end thicknesses, wherein the anti-aliasing is carried out by selecting a limited number of random samples such that multiple samples end up in each voxel within the segment, and wherein the specified end thickness is equal or smaller than the specified start thickness, and
elongating the segments by at least one of:
addition of a segment having a specified start thickness that is equal or smaller than the specified end thickness of the segment that is elongated, and/or
branching into two segments having equal or smaller thickness than the segment that is branched, wherein a string of branched segments follows a semi-linear or a curved line,
wherein the segments are non-overlapping.

16. The method of claim 13, comprising generating the 3D lesion model.

17. The method of claim 16, further comprising generating the 3D lesion model using multiple image phases.

18. The method of claim 13, further comprising training a deep neural network for blood vessel and/or lesion segmentation.

19. The method of claim 13, further comprising receiving and using real data to enhance the training of the DNN in addition to the training achieved using the synthetic training data.

20. A computer program product comprising a non-transitory computer readable storage medium having computer readable program embodied therewith, the computer readable program
configured to generate a 3D vessel model using a parametric blood vessel branching simulation and/or generate a 3D lesion model using a parametric lesion simulation, and
add a background to the generated 3D vessel and/or lesion model.
